(19) United States
(12) Patent Application Publication
(10) Pub. No.: US 2003/0231687 A1
(43) Pub. Date: Dec. 18, 2003

(54) Ultraviolet laser device

(76) Inventors: Osamu Wakabayashi, Hiratsuka-shi (JP); Hakaru Mizoguchi, Hiratsuka-shi (JP); Tatsuya Ariga, Hiratsuka-shi (JP)

Correspondence Address: VARNDELL & VARNDELL, PLLC, 106-A S. COLUMBUS ST., ALEXANDRIA, VA, 22314, US

(21) Appl. No.: 10/446,112

(22) Filed: May 28, 2003

(30) Foreign Application Priority Data
May 29, 2002 (JP) 2002-156439

(51) Int. Cl. H01S 3/22; H01S 3/223; H01S 3/08

(52) U.S. Cl. 372/55

(57) ABSTRACT

An ultraviolet laser device having optical elements which change polarized light of laser light to linearly polarized light, in which at least one of the optical elements through which the laser light passes is formed by annealing a crystal or glass, disposed so that the laser light passes therethrough substantially perpendicularly to a cleave plane and formed so that the cleave plane becomes substantially parallel to at least one of planes through which the laser light enters or leaves, and the cleave plane is a <111> plane of the crystal and disposed to be substantially perpendicular to a force applied to the optical element.

### BACKGROUND OF THE INVENTION

1. Field of the Invention

The present invention relates to an ultraviolet laser device.

2. Description of the Related Art

Conventionally known ultraviolet laser devices include an excimer laser device with a wavelength narrow-banded and a fluorine molecular laser device. FIG. 10 shows a top view of the ultraviolet laser device according to a related art, which will be described below with reference to FIG. 10.

In FIG. 10, an ultraviolet laser device 11 is provided with a laser chamber 12 in which laser gas is sealed. In the fluorine molecular laser system, for example, the laser gas contains fluorine and inert gas such as helium or neon and sealed in under, for example, an absolute pressure of about 3 to 4 atmospheres higher than atmospheric pressure.

The laser chamber 12 has therein a pair of main electrodes 14, 15 which are disposed to perpendicularly oppose the drawing of FIG. 10. An unshown fan for feeding the laser gas to between the main electrodes 14, 15 and an unshown heat exchanger for cooling the laser gas are also disposed in the laser chamber 12.

Windows 17, 19 allowing the passage of ultraviolet laser light 21 are respectively disposed before and after the laser chamber 12. The windows 17, 19 each are fixed to the laser chamber 12 with an unshown window holder (not shown in FIG. 10). The windows 17, 19 are respectively disposed at Brewster angle θB with respect to an optical axis of the ultraviolet laser light 21.

FIG. 11 shows a cross-sectional view of a window holder 37 for holding the rear window 19. The front window 17 is also held in the same manner. As shown in FIG. 11, the window holder 37 has the rear window 19 held between a base 37B and a lid 37A, which are fixed by clamping with bolts 42. And, O-rings 41, 41 are respectively held between the rear window 19 and the window holder 37 and between the window holder 37 and the laser chamber 12 to seal the laser gas. Thus, the windows 17, 19 are pressed against the O-ring via the lid 37A by tightening the bolts 42 to receive a force.

The surface (hereinafter called as the inside surface 19A) of the rear window 19 directly next to the laser chamber is in contact with the laser gas having a pressure equal to or higher than atmosphere pressure. Therefore, the rear window 19 is exposed to the pressure as indicated by arrows 36 from the inside surface 19A to the surface 19B (hereinafter called as the outside surface) of the rear window 19 away from the laser chamber.

In the description below, linearly polarized light passing through the windows 17, 19 disposed at the Brewster angle θB to the optical axis is called P polarized light, which is indicated by P in FIG. 11. Linearly polarized light perpendicular to the P polarized light and obstructed by the windows 17, 19 is called as the S polarized light and indicated by S in FIG. 11.

Then, the ultraviolet laser light 21 will be described.

In FIG. 10, a high voltage is applied from a high-voltage power supply 23 to between the main electrodes 14, 15 according to instructions from a laser controller 29 to cause main discharge. Thus, the laser gas is excited to produce the ultraviolet laser light 21.

The produced ultraviolet laser light 21 passes through, for example, the rear window 19 to enter a line-narrowing module 31. The line-narrowing module 31 has therein, for example, two prisms 32, 32 and a grating 33. The ultraviolet laser light 21 enters the inside surfaces of the prisms 32, 32 at an angle close to the Brewster angle θB and goes out substantially perpendicularly from an outside surface 32B. At this time, the ultraviolet laser light 21 is made to have an increased beam width by the prisms 32, 32.

The ultraviolet laser light 21 having entered the grating 33 has a wavelength close to a desired center wavelength diffracted on a diffracting plane and is reflected in the incident direction. The ultraviolet laser light 21 is repeatedly reflected between the grating 33 and a front mirror 16 which is disposed in front of the laser chamber 12 so to be amplified by the main discharge and partly passes through the front mirror 16 to go out. The output ultraviolet laser light 21 enters an exposure 25 such as a stepper to become exposure light.

At the time, the windows 17, 19 are disposed at the Brewster angle θB to the optical axis, so that the ultraviolet laser light 21 passing through the windows 17, 19 becomes almost P polarized light. Therefore, the P polarized light is amplified in the laser chamber 12, and the output ultraviolet laser light 21 also becomes almost P polarized light.

The above-described related art, however, has the following drawbacks.

Specifically, optical elements, such as the windows 17, 19 and the prisms 32, 32, through which the laser light 21 passes are formed of, for example, a crystal of fluoride such as calcium fluoride. Such a crystal of fluoride might cause birefringence when the laser light 21 passes through it.

The birefringence is intrinsically held by the crystal of fluoride or produced when a force is applied to the optical elements.

In the latter, the force includes a residual stress such as a thermal stress at the time of production of crystal and a force which is applied when the optical elements are held by a holder or the like. As shown in FIG. 11, the windows 17, 19 are fixed to the window holder 37 to receive the force. They also receive the force due to a pressure difference from atmosphere pressure in order to seal the high-pressure laser gas as indicated by the arrows 36 in FIG. 11.

The other optical elements such as the prisms 32, 32 are also exposed to a fixing force applied by an unshown holder, and the birefringence is caused as a result.

The passage of the laser light 21 through the optical elements having the birefringence mixes an S polarized light with a phase delayed in addition to the P polarized light to the laser light 21. The P polarized light passes at a high transmittance through the inside surfaces 32A, 32A of the prisms 32, 32, which are disposed at approximately the Brewster angle θB to the laser light 21, while the S polarized light is reflected from the inside surfaces 32A, 32A of the prisms 32, 32 and inside surfaces 17A, 19A of the windows 17, 19 as indicated by arrows 40. Part of the S polarized light impinges on the inside surface of the line-narrowing module 31, the prisms 32, 32 and the grating 33 to change to heat. As a result, the optical elements have an increased temperature, and a refractive index is partly changed. And, the laser light 21 may have a change in beam cross-sectional shape or intensity distribution. Besides, pulse energy may become low.

Another part of the S polarized light may reenter the light path of the laser light 21 and emerge from the front mirror 16. The S polarized light includes light which is not narrow-banded by the grating 33, so that the output laser light 21 may have its wavelength characteristics such as a spectral line width or center wavelength degraded. The degradation of the wavelength characteristics is caused when a stress applied to the optical element material is changed by the thermal expansion resulting from the temperature increase of the optical elements.

The present invention was achieved in view of the above-described drawbacks, and it is aimed to provide a laser device which stably emits laser light with the birefringence of the optical elements reduced.

### SUMMARY OF THE INVENTION

The present invention has been made in view of the above circumstances and provides an ultraviolet laser device, wherein at least one of optical elements, which configure a laser resonator and through which laser light passes, is formed by annealing a crystal.

Thus, a birefringence amount of the optical element is reduced and birefringence becomes hard to occur when the laser light passes through the optical element interior, so that the polarized light state of the laser light does not change much.

The ultraviolet laser device of the invention is featured in that at least one of the optical elements is disposed so that the laser light passes therethrough substantially perpendicularly to its cleave plane.

When the laser light passes through the cleave plane perpendicularly, birefringence hardly occurs, so that the polarized light state of the laser light does not change much.

The ultraviolet laser device of the invention is featured in that the optical element is formed so that a cleave plane becomes substantially parallel to at least one of planes through which the laser light enters and leaves.

Thus, when the planes of incidence and outgoing are configured so that the laser light passes substantially perpendicularly, the configuration to reduce the birefringence can be realized with ease.

And, at the time when the planes of incidence and outgoing are polished, they can be polished with high precision.

The ultraviolet laser device of the invention is featured in that the cleave plane is a <111> plane or a <100> plane of the crystal.

When the laser light passes substantially perpendicularly to the <111> plane of the cleave plane, the birefringence becomes particularly small. And, when the laser light passes substantially perpendicularly to the <100> plane, the birefringence becomes relatively small.

The ultraviolet laser device of the invention is featured in that at least one of the optical elements is disposed so that the cleave plane becomes substantially perpendicular to a force applied to the optical element.

When the optical element has a force applied substantially perpendicularly to the cleave plane, particularly the <111> plane, the birefringence hardly occurs.

The ultraviolet laser device of the invention is featured in that the crystal is fluoride.

Specifically, the fluoride allows the passage of the ultraviolet laser light at high transmittance, so that it is suitable as the optical element of the resonator.

The ultraviolet laser device of the invention is featured in that the fluoride is calcium fluoride.

Specifically, the calcium fluoride has the smallest birefringence which is originally possessed by the material among the substances which allow the passage of the ultraviolet laser light.

The ultraviolet laser device of the invention is featured in that at least one of the optical elements configuring the ultraviolet laser device has selectivity of polarized light in a given direction of the ultraviolet laser light.

Thus, when the laser light of linearly polarized light is to be emitted, the birefringence is small, so that the laser light seldom becomes oval polarized light, and laser light of desired polarized light can be obtained.

The present invention further provides an ultraviolet laser device, wherein at least one of optical elements, which configure a laser resonator and through which laser light passes, is formed by annealing glass.

For example, when the ultraviolet laser device is a KrF excimer laser device, synthetic quartz may be used as the optical element of the resonator, and the synthetic quartz is also made to have the birefringence become small by annealing and the strength increased.

### BRIEF DESCRIPTION OF THE DRAWINGS

FIG. 1 is a top view of a fluorine molecular laser device according to a first embodiment of the invention;

FIG. 2 is a flow chart showing a procedure for production of an optical element;

FIG. 3 is a top view of an optical element of the fluorine molecular laser device according to a second embodiment of the invention;

FIG. 4 is an explanatory diagram showing a birefringence amount of a calcium fluoride crystal;

FIG. 5 is a top view showing another configuration of the optical element of the fluorine molecular laser device according to the second embodiment of the invention;

FIG. 6 is a top view of the fluorine molecular laser device according to a third embodiment of the invention;

FIG. 7 is a sectional view of an etalon holder;

FIG. 8 is a top view of the fluorine molecular laser device according to a fourth embodiment of the invention;

FIG. 9 is a top view showing another configuration of the fluorine molecular laser device according to the fourth embodiment of the invention;

FIG. 10 is a top view of the fluorine molecular laser device according to prior art; and

FIG. 11 is a sectional view of a window holder.

### DETAILED DESCRIPTION OF THE PREFERRED EMBODIMENTS

Preferred embodiments of the present invention will be described in detail with reference to the accompanying drawings.

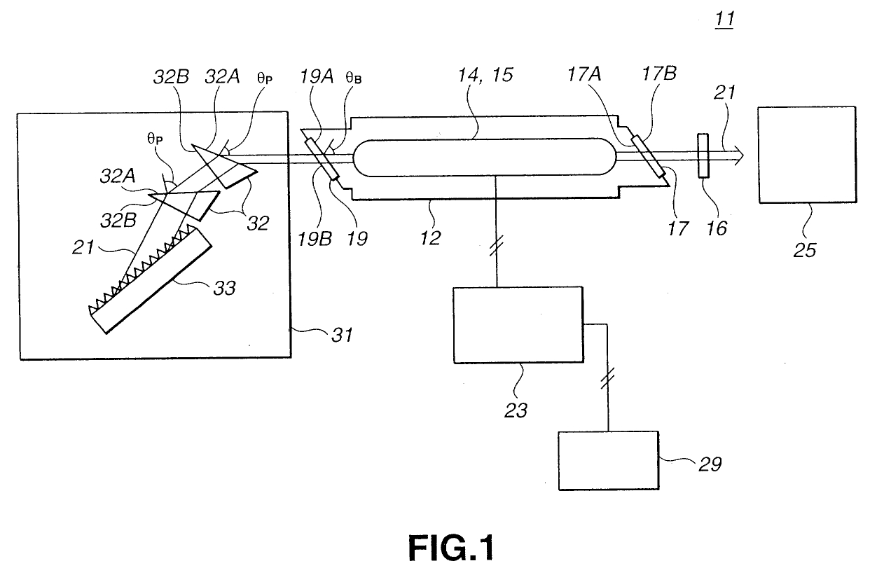

First, a first embodiment will be described. FIG. 1 shows a top view of a fluorine molecular laser device 11 according to this embodiment. In FIG. 1, the fluorine molecular laser device 11 is provided with a laser chamber 12 in which laser gas is sealed.

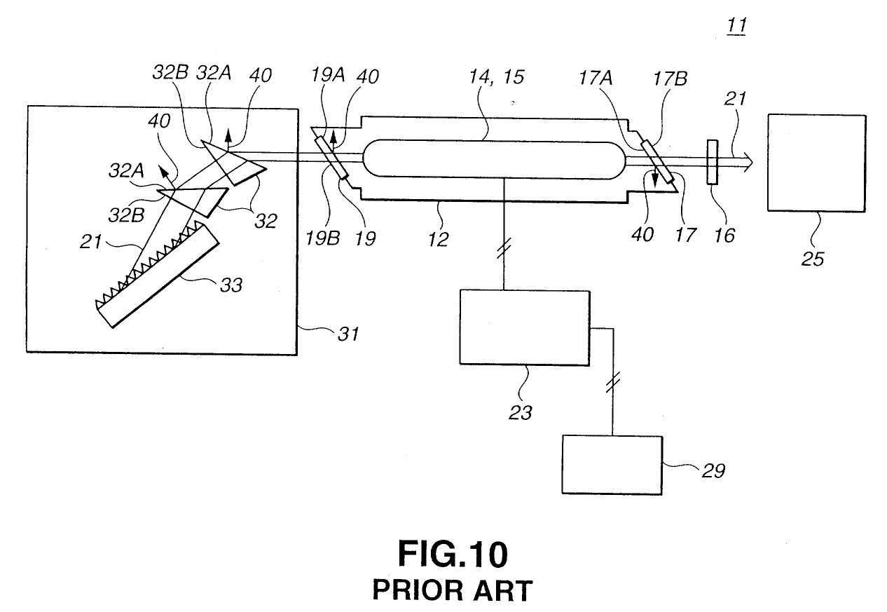

The laser chamber 12 has therein a pair of main electrodes 14, 15 which are disposed to perpendicularly oppose the drawing of FIG. 10. An unshown fan for feeding the laser gas to between the main electrodes 14, 15 and an unshown heat exchanger for cooling the laser gas are also disposed in the laser chamber 12.

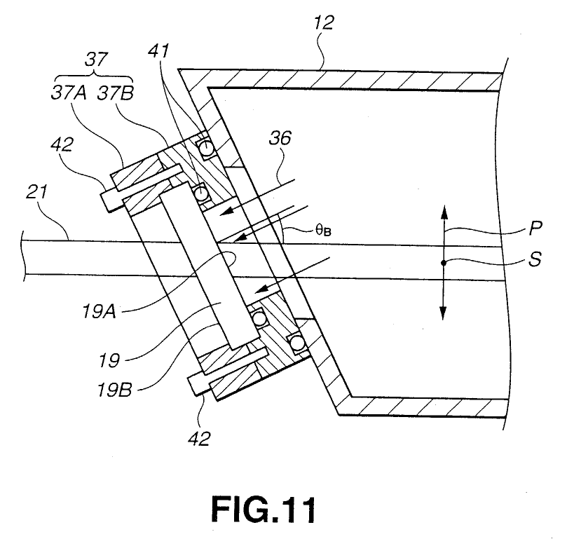

Windows 17, 19 allowing the passage of ultraviolet laser light 21 are respectively disposed before and after the laser chamber 12 by a window holder 37 (not shown in FIG. 1) as shown in FIG. 11.

In FIG. 1, a high voltage is applied from a high-voltage power supply 23 to between the main electrodes 14, 15 according to instructions from a laser controller 29 to produce a main discharge. Thus, the laser gas is excited to produce the fluorine molecular laser light 21 having a wavelength of approximately 157 nm.

For example, the produced laser gas passes through the rear window 19 to enter a line-narrowing module 31. The line-narrowing module 31 has therein, for example, two prisms 32, 32 and a grating 33. The fluorine molecular laser light 21 enters the prisms 32, 32 at an entry angle θP approximate to the Brewster angle θB to inside surfaces 32A, 32A of the prisms 32, 32 and emerges substantially perpendicularly from an outside surface 32B. At that time, the fluorine molecular laser light 21 has its beam width increased by the prisms 32, 32.

The fluorine molecular laser light 21 having entered the grating 33 has only a wavelength close to a desired center wavelength diffracted on a diffracting plane and is reflected in the incident direction. The fluorine molecular laser light 21 is repeatedly reflected between the grating 33 and the front mirror 16 which is disposed in front of the laser chamber 12 so to be amplified by the main discharge and partly passes through the front mirror 16 to go out.

The output fluorine molecular laser light 21 enters an exposure 25 such as a stepper as exposure light.

As materials for the optical elements such as the prisms 32, 32, the grating 33, the windows 17, 19 and the front mirror 16, calcium fluoride (CaF₂) is used. When calcium fluoride is used, the fluorine molecular laser light 21 has the Brewster angle θB of approximately 57.3 degrees.

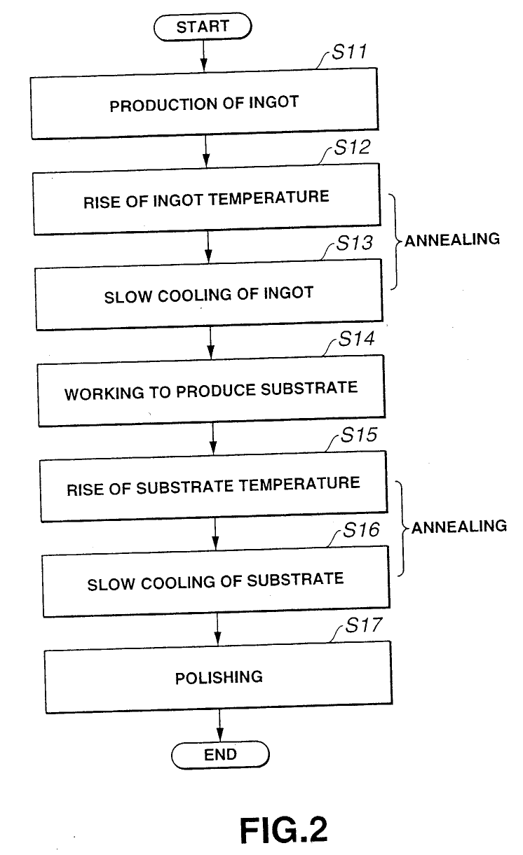

FIG. 2 shows a flow chart of a procedure for production of an optical element, e.g., the windows 17, 19.

First, calcium fluoride to be a material for the optical element is melted, and a monocrystalline ingot is produced from the molten material (step S11). The method for production of the ingot includes, for example, a method of growing a monocrystal by, for example, a pull method, a method of gradually cooling the molten material from an end, and the like.

Then, the produced ingot is cooled, placed in a furnace, raised its temperature up to a prescribed temperature at which the ingot does not melt (step S12), and slowly cooled over a prescribed time (step S13). Steps S12, S13 are annealing, thereby removing a residual stress from the interior of calcium fluoride and reducing a birefringence amount.

The birefringence amount indicates a delay amount of polarized light having a slow speed when the polarized light of a high speed propagates within the optical element by 1 cm and indicated in nm/cm.

After the annealing is completed, the ingot is machined into substrates having the shape of the windows 17, 19 (step S14). The machined substrates are placed in the furnace again and raised their temperatures up to a prescribed temperature (step S15) and gradually cooled over a prescribed time (step S16).

Specifically, additional annealing is performed in the steps S15, S16, so that the birefringence amount is further reduced. The annealing temperature and time in the steps S15, S16 are not limited to be the same as in the steps S12, S13.

The inside surfaces 17A, 19A and the outside surfaces 17B, 19B of the annealed windows 17, 19 are polished (step S17). Thus, the production of the windows 17, 19 is completed.

The windows 17, 19 were described above as an example, but the other optical elements such as the prisms 32, 32 and the front mirror 16 are also processed in the same way. Prescribed coating may be applied to the surface depending on a type of optical element after the step S17.

As described above, annealing is conducted in the process of producing the optical elements according to the first embodiment. Thus, the crystalline structure of each optical element is stabilized, and the birefringence originally possessed by the optical element and the birefringence produced when the optical element is produced become very small.

It is also known that the birefringence, which is produced by the force received from the holder when the optical element is attached to the holder or the force that the windows 17, 19 receive from a difference in pressure between the laser gas and the atmosphere (arrows 36 in FIG. 10), can be reduced by annealing.

Thus, S polarized light is seldom mixed into the fluorine molecular laser light 21 having passed through the optical element, and P polarized light has high purity.

As a result, the fluorine molecular laser light 21 reflected from the inside surfaces 32A, 32A of the prisms 32, 32 and the inside surfaces 17A, 19A of the windows 17, 19 is reduced. Therefore, it is seldom that pulse energy of the fluorine molecular laser light 21 is lowered or the fluorine molecular laser light 21 not narrow-banded is mixed into the laser chamber 12.

Besides, the line-narrowing module 31 is seldom heated its interior by the reflected fluorine molecular laser light 21, and the optical element or a light path space (if not vacuum) through which the laser light 21 passes seldom has a change in refractive index. Therefore, it is possible to obtain the fluorine molecular laser light 21 having a stable beam cross-sectional shape, wavelength characteristics and pulse energy.

Referring to the flow chart of FIG. 2, it was described to perform two times of annealing in the steps S12, S13 and steps S15, S16, but the two times of annealing is not essential, and only one of them may be performed. Besides, additional annealing may be performed after the step S17.

It was also described above that the temperature is raised in the steps S12, S15 and gradually lowered in the steps S13 and S16 to perform only one set of temperature increase and decrease. But, it is not a limited procedure. For example, the steps S12, S13 may be repeated a plurality of times just after the annealing is performed in the steps S12, S13.

Then, a second embodiment will be described.

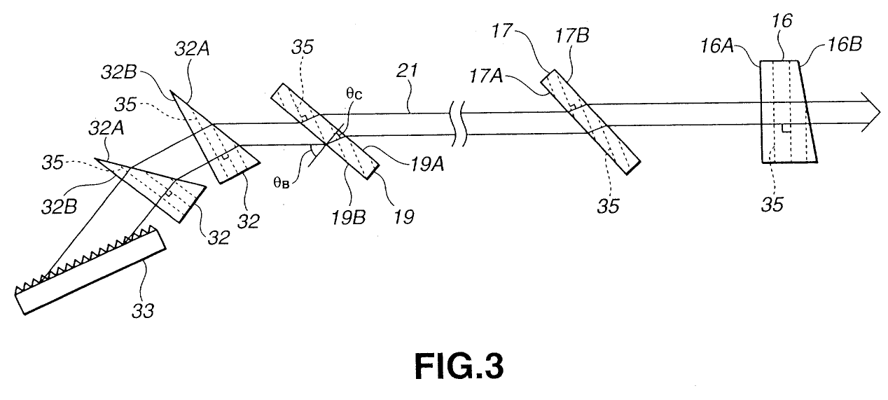

FIG. 3 shows a top view of the structure of the optical elements in the fluorine molecular laser device 11 according to the second embodiment. Each optical element is previously annealed as described in the first embodiment. In FIG. 3, a cleave plane 35 of a calcium fluoride crystal of each optical element is indicated by a broken line. As the cleave plane 35, a <111> plane which has a minimum birefringence amount is optimum. And, a <100> plane which does not match the <111> plane but has a relatively small birefringence amount in the cleave plane 35 may be used.

First, the prisms 32, 32 are configured to have their outside surfaces 32B, 32B substantially parallel to the cleave planes 35, 35. And, the prisms 32, 32 are disposed so that the fluorine molecular laser light 21 passes through the prisms 32, 32 substantially perpendicularly to their cleave planes 35, 35.

The windows 17, 19 are disposed at the Brewster angle θB to the optical axis of the fluorine molecular laser light 21 as described above. In that state, the cleave plane 35 is configured to make the fluorine molecular laser light 21 pass through the windows 17, 19 substantially perpendicularly to the cleave plane 35.

At that time, the fluorine molecular laser light 21 enters the surfaces 17A, 17B, 19A, 19B of the windows 17, 19 at an entry angle of the Brewster angle θB and refracts there. When it is assumed that calcium fluoride has a refractive index of 1.56 and the Brewster angle θB is 57.3 degrees, the fluorine molecular laser light 21 which outgoes the surfaces 17A, 17B, 19A, 19B of the windows 17, 19 has an outgoing angle θC of approximately 32.6 degrees. In other words, the cleave planes of the windows 17, 19 are formed to be substantially perpendicular to the fluorine molecular laser light 21 having the outgoing angle θC to the surfaces 17A, 17B, 19A, 19B.

Besides, the inside surface 16A of the front mirror 16 is disposed to be substantially perpendicular to the optical axis of the fluorine molecular laser light 21, and the cleave plane 35 is configured to be substantially parallel to the inside surface 16A. The outside surface 16B of the front mirror 16 is slanted so to be not parallel to the inside surface 16A.

According to the second embodiment as described above, the optical element made of calcium fluoride is annealed and disposed so that the fluorine molecular laser light 21 passes through the optical element substantially perpendicularly to the cleave plane 35 of the crystal. Thus, the birefringence amount of the optical element which has become small by annealing can further be made smaller. Besides, a much smaller birefringence amount can be obtained by using the <111> plane as the cleave plane 35.

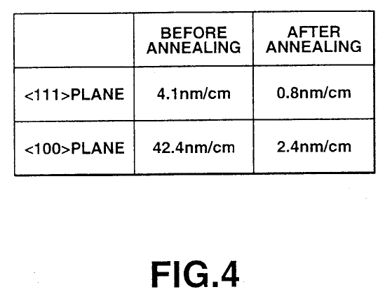

FIG. 4 shows a birefringence amount under application of a prescribed stress with and without annealing of the <111> and <100> planes of a calcium fluoride crystal. As shown in FIG. 4, when the annealing is not performed, the <100> plane has a birefringence amount of 42.4 nm/cm by the stress, but when the annealing is performed, it has birefringence amount of 2.4 nm/cm. When the annealing is not performed, the <111> plane originally has a very small birefringence amount of 4.1 nm/cm by the stress, but when the annealing is performed, it has a birefringence amount of only 0.8 nm/cm.

In other words, a very small birefringence amount is obtained by annealing so to produce and dispose the optical element which allows the laser light to pass through the <111> plane perpendicularly.

When the optical element is configured so that the plane into which the fluorine molecular laser light 21 enters becomes parallel to the <111> plane, the plane of incidence can be polished with high accuracy. Therefore, fluctuations in a wave front on the plane of incidence are reduced, and the fluorine molecular laser light 21 with high quality can be obtained.

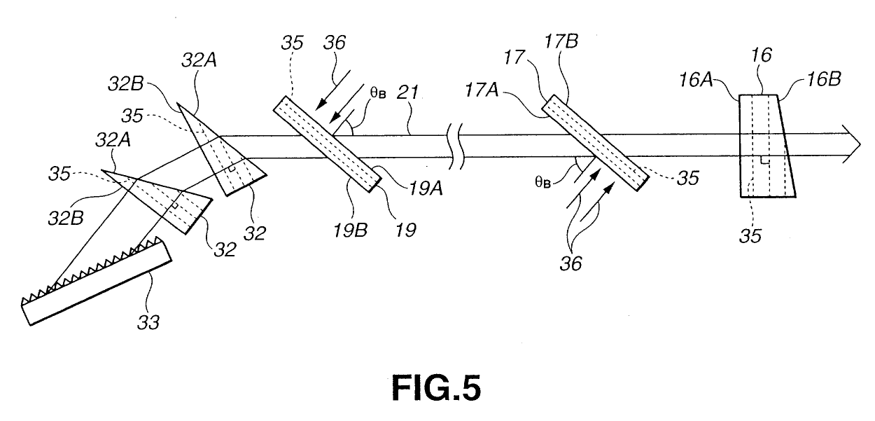

FIG. 5 shows a top view of another example of configuration of the optical elements in the fluorine molecular laser device 11 according to the second embodiment. In FIG. 5, the windows 17, 19 are configured to have the cleave plane 35 (especially, the <111> plane) substantially parallel to the inside surfaces 17A, 19A and the outside surfaces 17B, 19B and are annealed when produced.

The inside surfaces 17A, 19A of the windows 17, 19 are in contact with the laser gas, and the outside surfaces 17B, 19B are in contact with the atmosphere. As described above, because the laser gas is sealed in the laser chamber (not shown) under a pressure considerably higher than the atmosphere pressure, the pressure of the laser gas is applied to the windows 17, 19 substantially perpendicularly to the inside surface 19A (arrows 36).

At that time, the windows 17, 19 have the highest strength to a force perpendicularly applied to the cleave plane 35 (especially, the <111> plane). Therefore, when the cleave plane 35 is disposed to be parallel to the inside surface 19A, the strength of the windows 17, 19 is increased, and the increase in birefringence caused by distortion of the windows 17, 19 becomes very small. Durability of the windows 17, 19 to the pressure of laser gas is improved. And, the windows 17, 19 are produced with ease.

Then, a third embodiment will be described.

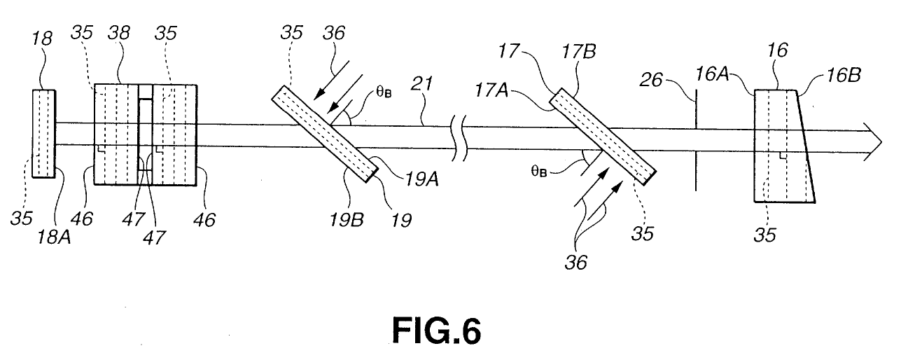

FIG. 6 shows a top view of the fluorine molecular laser device 11 according to the third embodiment. In FIG. 6, the fluorine molecular laser device 11 is provided with the laser chamber 12, which has the windows 17, 19 at either end, the front mirror 16 for emitting the laser light 21, an etalon 38 for narrow-banding the laser light 21, and the rear mirror 18 for total reflection of the laser light 21.

The laser light 21 produced in the laser chamber 12 has its wavelength narrow-banded by the etalon 38. And, the laser light 21 is amplified while being reciprocated between the rear mirror 18 and the front mirror 16 and partly passes through the front mirror 16 to go out.

The etalon 38 configured with a spacer 45 made of low-expansion glass held between two disc type parallel flat boards 44, 44. A partial reflective coating is applied to surfaces 47, 47 of the parallel flat boards 44, 44 on the side of the spacer 45, and a nonreflective coating is applied to the surfaces 46, 46 opposite to the surfaces 47, 47. The cleave planes 35, 35 are produced to be parallel to the parallel flat boards 44, 44.

For the fluorine molecular laser device 11 described above, the optical element is previously annealed and then produced and disposed to direct the cleave plane 35, particularly the <111> plane, substantially perpendicularly to the optical axis of the laser light 21.

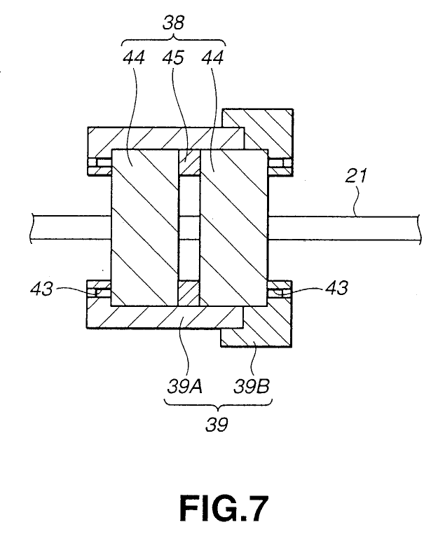

FIG. 7 shows a cross-sectional view of an etalon holder 39 for holding the etalon 38. The etalon holder 39 is configured by fixing, for example, an inner tube 39A and an outer tube 39B, and fixes the etalon by tightening in screws 43 from both sides of the etalon holder 39. Thus, the screws 43 apply a force to the etalon 38 to produce birefringence, but the birefringence can be minimized by producing and disposing the cleave plane 35, especially the <111> plane, to be substantially perpendicular to the optical axis of the laser light 21.

It is not illustrated but the cleave plane 35 may be configured to be substantially perpendicular to the optical axis in the same way when the prisms 32, 32 and the grating 33 described in the first embodiment are used instead of the rear mirror 18 to make the wavelength more narrow-banded.

When the etalon 38 is used as an output coupler, the cleave plane 35 of the etalon 38 is desired to be substantially perpendicular to the optical axis.

The rear mirror 18 may also be produced and disposed to have cleave plane 35 substantially parallel to the reflecting plane 18A of the laser light 21. The rear mirror 18 does not allow the passage of the laser light 21, so that no birefringence is produced in it, but when the cleave plane 35 is disposed to be substantially parallel to the reflecting plane 18A, the reflecting plane 18A can be polished with higher precision.

To hold the rear mirror 18, the reflecting plane 18A is held by an unshown holder, so that distortion of the reflecting plane 18A due to holding is reduced by disposing the cleave plane 35 to be substantially parallel to the reflecting plane 18A.

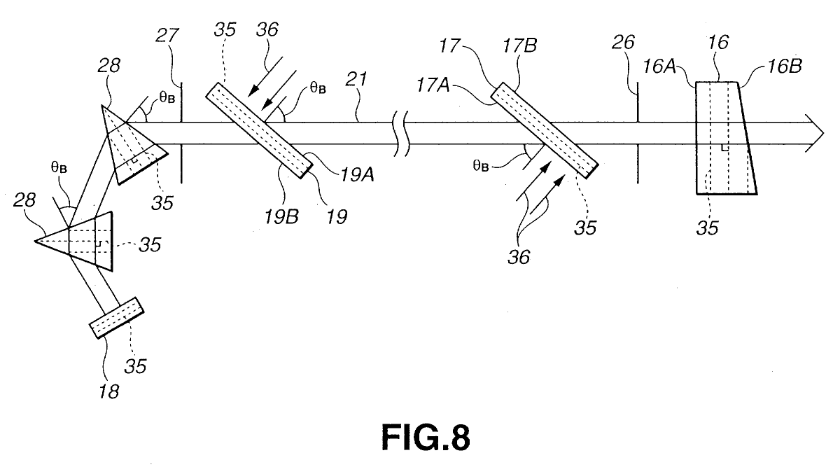

Then, a fourth embodiment will be described. FIG. 8 shows a top view of the fluorine molecular laser device 11 according to the fourth embodiment. In FIG. 8, the fluorine molecular laser device 11 is provided with, for example, two dispersion prisms 28, 28 and the rear mirror 18 disposed behind the laser chamber 12. And, slits 26, 27 are disposed before and after the laser chamber 12.

The fluorine molecular laser light 21 includes intense line light (center wavelength of approximately 157.63 nm) with a long wavelength and weak line light (center wavelength of approximately 157.52 nm) with a short wavelength together. The intense line light and the weak line light are different in wavelength, so that they have a different refraction angle when they enter and leave the dispersion prisms 28, 28. Therefore, the intense line light and the weak line light have their light path gradually deviated from each other while passing through the dispersion prisms 28, 28.

Specifically, the intense line light passes through the dispersion prisms 28, 28, reflects from the rear mirror 18, passes through the windows 17, 19, passes through the dispersion prisms 28, 28 again, passes through the slits 26, 27, and partly passes through the front mirror 16 to go out.

Meanwhile, the weak line light is caused to deviate its light path while reciprocating between the dispersion prisms 28, 28, passes through the front window 17, and is obstructed by the slits 26, 27 to stop oscillating. It is called single lining. Here, the single lining is assumed to be a kind of narrow banding.

The dispersion prisms 28, 28 are also made of calcium fluoride and configured so that the laser light 21 passes through the cleave plane 35 substantially perpendicularly to it as shown in FIG. 8. For example, when the dispersion prisms 28, 28 are formed to have the shape of an isosceles triangle as viewed from above as shown in FIG. 8, the dispersion prisms 28, 28 are produced in such a way that the cleave plane 35 becomes parallel to a bisector of the vertical angle of the isosceles triangle. And, the incident angle of the laser light 21 to the dispersion prisms 28, 28 is assumed to be the Brewster angle θB.

Thus, birefringence hardly occurs, and generation of S polarized light is reduced even when the laser light 21 passes through the dispersion prisms 28, 28.

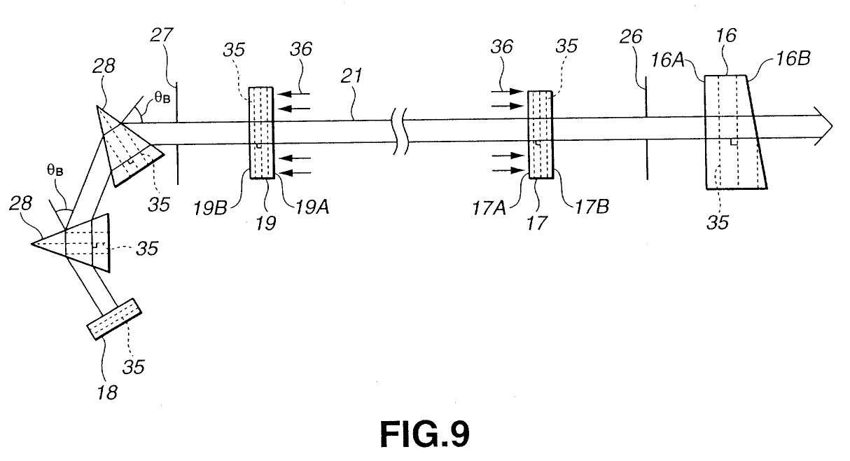

FIG. 9 shows another example of configuration of the fluorine molecular laser device 11 according to the fourth embodiment. As shown in FIG. 9, the windows 17, 19 of the fluorine molecular laser device 11 are disposed not to have the Brewster angle θB but substantially right angles to the optical axis as described in the above individual embodiments.

Specifically, the windows 17, 19 disposed, so that the cleave planes 35, 35 have the Brewster angle θB to the inside surfaces 17A, 19A as shown in FIG. 1 and have an advantage that a loss is less, but their production might be hard. As described above, when the cleave planes 35, 35 are exposed to the pressure of the laser gas (arrows 36), the inside surfaces 17A, 19A or the outside surfaces 17B, 19B may be deformed because the cleave planes 35, 35 are not perpendicular to the pressure.

According to the fluorine molecular laser device 11 as shown in FIG. 9, the fluorine molecular laser light 21 becomes substantially the P polarized light when it enters the dispersion prisms 28, 28 at the Brewster angle θB. And, the fluorine molecular laser light 21 passes through the dispersion prisms 28, 28 substantially perpendicularly to the cleave plane 35, so that birefringence hardly occurs, and the S polarized light is seldom mixed.

The fluorine molecular laser light 21 suffers from a slight loss because it enters substantially perpendicularly the windows 17, 19 and passes through the windows 17, 19 substantially perpendicularly to the cleave plane 35. Thus, birefringence hardly occurs, and the S polarized light is seldom mixed.

And, the windows 17, 19 are highly durable to the pressure and have low occurrence of birefringence by the pressure because the cleave planes 35 are substantially perpendicular to the pressure of the laser gas.

The above description was made on the fluorine molecular laser device as an example, but the present invention can be applied to an ultraviolet laser device such as KrF, ArF excimer laser with a wavelength of approximately 193 nm, or the like.

The laser device having a wavelength narrow-banded was described as an example, but the windows 17, 19 and the front mirror 16 are effective even when the wavelength is not narrow-banded. Specifically, the optical element is lowered its birefringence amount by annealing as described in the above respective embodiments. As a result, the fluorine molecular laser light 21 passing through the optical element does not cause birefringence. And the fluorine molecular laser light 21 of linearly polarized light can be obtained at all times.

Besides, when it is configured to have the cleave plane 35 to be substantially parallel to the plane in or from which the fluorine molecular laser light 21 enters or exits, the plane polishing precision is improved. Besides, the windows 17, 19 are improved their durability to the pressure of the laser gas when the cleave planes 35, 35 are configured to be substantially parallel to the inside surfaces 17A, 19A.

Furthermore, the material for the optical element in the above description was calcium fluoride. It was because the calcium fluoride had the smallest birefringence amount among the materials through which the ultraviolet laser light passed and was suitable as the optical element.

However, the present invention is also effective on another fluoride, which allows the passage of the ultraviolet laser light, such as magnesium fluoride (MgF₂) or lithium fluoride (LiF₂). When the laser device oscillates laser light having a relatively long wavelength (248 nm) such as the KrF excimer laser device, glass such as synthetic quartz, which allows the passage of light having the above wavelength, is used as the optical element. Glass does not have a cleave plane but has a small birefringence when it is annealed. Therefore, the present invention is also effective on glass.

The inside surfaces 17A, 19A and the outside surfaces 17B, 19B of the windows 17, 19 described were disposed to be parallel to each other. They may not be disposed to be parallel, and the cleave plane 35 may be arranged to be parallel to the inside surfaces 17A, 19A.

What is claimed is:

1. An ultraviolet laser device, wherein at least one of optical elements, which configure a laser resonator and through which laser light passes, is formed by annealing a crystal.

2. The ultraviolet laser device according to claim 1, wherein said at least one of the optical elements is disposed so that the laser light passes therethrough substantially perpendicularly to its cleave plane.

3. The ultraviolet laser device according to claim 2, wherein said at least one of the optical elements is formed so that the cleave plane becomes substantially parallel to at least one of planes through which the laser light enters and leaves.

4. The ultraviolet laser device according to claim 3, wherein the cleave plane is a <111> plane or a <100> plane of the crystal.

5. The ultraviolet laser device according to claim 1, wherein said at least one of the optical elements is disposed so that the cleave plane becomes substantially perpendicular to a force applied to the optical element.

6. The ultraviolet laser device according to claim 2, wherein said at least one of the optical elements is disposed so that the cleave plane becomes substantially perpendicular to a force applied to the optical element.

7. The ultraviolet laser device according to claim 3, wherein said at least one of the optical elements is disposed so that the cleave plane becomes substantially perpendicular to a force applied to the optical element.

8. The ultraviolet laser device according to claim 4, wherein said at least one of the optical elements is disposed so that the cleave plane becomes substantially perpendicular to a force applied to the optical element.

9. The ultraviolet laser device according to claim 1, wherein the crystal is fluoride.

10. The ultraviolet laser device according to claim 9, wherein the fluoride is calcium fluoride.

11. The ultraviolet laser device according to claim 1, wherein said at least one of the optical elements configuring the ultraviolet laser device has selectivity of polarized light in a given direction of the ultraviolet laser light.

12. An ultraviolet laser device, wherein at least one of optical elements, which configure a laser resonator and through which laser light passes, is formed by annealing glass.
